(19) United States
(12) Patent Application Publication
(10) Pub. No.: US 2003/0144938 A1
(43) Pub. Date: Jul. 31, 2003

(54) Method and system for cash maximization

(76) Inventors: Robert Lahre, Kansas City, MO (US); Wolfram Kursten, Leawood, KS (US)

Correspondence Address: POLSINELLI SHALTON & WELTE, P.C., 700 W. 47TH STREET, SUITE 1000, KANSAS CITY, MO, 64112-1802, US

(21) Appl. No.: 10/059,493

(22) Filed: Jan. 29, 2002

(51) Int. Cl. G06F 17/60

(52) U.S. Cl. 705/36; 705/35

(57) ABSTRACT

The present invention relates to a method and system for maximizing cash inventory. More specifically, the invention relates to a method and system for obtaining customer financial data and producing purchase recommendations which maximize the customer's cash inventory over a customer-defined period. In a process that is completely invisible to the customer, the customer's financial data is transferred to a vendor, the data is prepared for processing by an optimization engine, the data is optimized using the engine, and resulting recommendations are sent to the customer. The tasks of processing the data and transferring it to the optimization engine, as well as transferring the optimized data from the optimization engine and preparing it for transfer to the customer, are accomplished by an optimization interface. The method allows the customer to input financial data into a computer and receive resulting reports from the same computer without having to do any data manipulation, programming, or calculations. The customer can also input financial data, request and receive reports, and submit change requests using an Internet-based dashboard interface, making the process even more convenient for the customer. Thus, by simply entering its financial data into a web-based user interface, a customer can receive product inventory purchase recommendations that will maximize the customer's cash inventory.

### FIELD OF THE INVENTION

The present invention relates to a computer-implemented method and system for enhanced supply chain management. More specifically, the invention relates to a prepackaged method and system for maximizing return of cash inventory which utilizes optimization software to supply a solution for purchasing and distributing inventory without customer manipulation whereby the customer need only supply data and receive purchase recommendations.

### BACKGROUND OF THE INVENTION

Supply chain management (SCM) is the oversight of materials, information, and finances as this information moves in a process from supplier to manufacturer to wholesaler to retailer to consumer. Concerned with the linkages in the supply chain from primary producer to final consumer, SCM involves forecasting, resource allocation, production planning, flow and process management, inventory management, customer delivery, after-sales support and service, and related business activities. In practice, SCM is used to analyze the relationships that exist between each of the units in the supply chain in order to achieve greater efficiency and cost savings.

Since the 1960s, optimization technology has helped many companies across multiple industries, including manufacturers with production planning, airlines with flight schedules and yield management, and investment companies with portfolio management. Due to advances in computing power and sophisticated algorithms, optimization is gaining rapid acceptance as the most effective approach to developing business-to-business e-commerce solutions—particularly in supply chain management and strategic sourcing of direct goods and services.

Use of optimization technology allows businesses to simultaneously consider a multitude of interdependent factors for each and all of its suppliers before recommending an optimal solution. Such a system can examine an entire problem, including all of the interconnected variables concurrently, and then generate an optimal solution.

Optimization attempts to minimize or maximize a function subject to equality or inequality constraints. In its simplest terms, optimization solves business problems involving many interconnected variables as a set of mathematical equations. These equations are solved with the help of software that restates the best solution in practical business terms. Optimization combines applied mathematics, computer science, and financial accounting to identify an optimal solution to a given problem that would otherwise be difficult or impossible to solve.

Optimization problems are comprised of three chief components:

1. An objective function which is sought to be achieved, often by minimization or maximization. For instance, in a manufacturing process, it might be sought to maximize the profit or minimize the cost.

2. A set of variables that affect the value of the objective function. In a manufacturing problem, the variables might include the amounts of different resources used or the time spent on each activity.

3. A set of constraints that allow the unknowns to retain certain values but not others. For a manufacturing problem, it does not make sense to spend a negative amount of time on any activity, so all the “time” variables are constrained to be non-negative.

Thus, the goal of optimization is to determine which values of the variables minimize or maximize the objective function while satisfying the constraints. In order to accomplish this goal, optimization software must be utilized. Optimization software uses a complex series of algorithms to solve for the objective function. Though many different types of optimization software exist, most utilize the “branch and bound” method to simultaneously solve multiple equations until an optimal solution is obtained. The branch and bound method guarantees an optimal solution so long as sufficient time exists for the search. The process is a two step process:

1. Branch—Try all possible decisions that are needed to solve an optimization problem.

2. Bound—Cancel any further work on a sequence of such decisions if it can be guaranteed that this sequence will not lead to an optimal solution.

Bounding becomes possible by using an estimating function within the optimization software. This estimating function determines, from the current point in the process, the best solution containing all the decisions of the decision sequence.

The chief component of optimization software is the optimization engine. This is the part of the software that uses a complex series of algorithms to solve for the variables to achieve the objective function. The algorithms solve multiple equations consisting of the variables subject to the constraints. Thus, data is inputted into the optimization engine, and an optimized result is outputted. The optimized result is the solution which best achieves the objective function based on the equations and variables while satisfying the constraints. Thus, there is only one optimized result.

Before the optimization engine optimizes data by simultaneously solving multiple equations, this data must first be assembled and inputted into the optimization engine. Specifically, a software interface must first be designed and built so that the optimization engine can accept customer data, solve for the objective function, and generate a relevant report instructing a customer what actions to take so that the objective function is achieved. Without this additional software interface, the optimization engine is useless. There must be an interface between the optimization engine—which contains the optimization algorithms, is not particular to any customer or field, and can be obtained from many alternative sources—and the customer. This customer interface feeds the data to be optimized into the optimization engine, retrieves the results, and allows the customer to change constraints or variable values and/or restart the optimization engine.

Current methods of product inventory optimization place responsibility for design, implementation, and maintenance of the optimization interface software upon the customer, with the vendor only supplying the optimization engine. The customer must either provide the customer interface itself or outsource this step. While this essential step can be managed in-house, designing, implementing, and maintaining an efficient and effective interface requires a dedicated information technology (IT) team sophisticated enough to handle the required programming. This commitment of time, as well as financial and human resources precludes all but large businesses that can afford to staff a dedicated IT department from fully utilizing optimization technology. In addition, if those individuals responsible for maintaining the interface depart the customer's employ for any reason, finding and training new support staff can be difficult and costly.

Design and maintenance of the interface may alternatively be outsourced to third party IT providers. While the problem of departing support staff is lessened since the customer will be able to contract with the third party so as to protect itself in case of departure of key third party employees, dissolution of the third party provider is always a possibility, as is the possibility that replacement staff provided by the third party may perform at contracted service levels, but not the same levels as previous staff. In any case, such outsourcing is costly in payments to the third party provider as well as in transaction costs such as legal fees required for contracting with the third party. It is thus desired to have a prepackaged optimization method whereby the customer need only supply data and receive purchase recommendations. Such a method would provide the customer interface for the optimization engine. This method would not require the customer to be involved in each step of the optimization process nor would it require any input or effort on the part of the customer other than simply supplying financial data.

Current optimization methods do not allow for quick and easy analysis of changes in variables and constraints within the optimization process. The ability to view the effects of such changes is important for businesses attempting to select their best option. Such changes in variables and constraints can significantly impact profitability. For example, if a customer wants to change the average lead time (the amount of time between the placing of an order and the receipt of the goods ordered) under current methods, the customer (or its third party IT provider) must make a change in the optimization interface software to reflect the new information. Such a change requires significant time to implement as well as added cost for programmers to alter the code. In addition, each change made to the code increases the chance for error, particularly if the programming is done in-house by programmers who are not dedicated to optimization. Thus, an optimization method is desired in which the customer can make changes to variables and constraints by simply issuing change requests without the customer having to change either the optimization engine software or the interface software. Such a method would save the customer time and money by not having to make these changes. Further, it would allow for better-informed business decisions since more possibilities could be explored, such as working with a range of constraints and variables. Finally, such a method would minimize the chance of coding errors because of increased efficiency due to vendor's familiarity with optimization programming.

Previous optimization efforts in SCM have focused on reducing product inventory. Product inventory optimization is a process whereby distributors can reduce the amount of stock they carry, thus reducing storage costs, insurance costs, and taxes, while improving or maintaining service levels. This ensures that the right stock is available when and where it is needed, which increases turnover (the number of times a particular stock of goods is sold and restocked during a given period of time), and reduces lost sale opportunities.

The ultimate goal of product inventory optimization systems is the same as the goal of all businesses: to maximize profit. However, there are some times when minimizing product inventory does not maximize profit. For example, the inflexibility that comes from being tied to minimal product inventory can be seen clearly in a case where a merchant needs to buy 400 widgets over a month in order to maintain enough stock to sell to his customers. If the merchant's supplier has a fire sale on widgets for 90% off their normal price, it would likely maximize profitability to purchase a full month supply of 400 widgets at once at the sale price. Under a product inventory minimization model, such a choice would not be examined as a possibility by the optimization engine since it would not minimize product inventory. Instead, 100 widgets would be purchased each week, so that the merchant would obtain the sale price on only 100. Product inventory optimization thus sometimes fails to produce the ultimate goal of profit maximization.

In addition, product inventory minimization possesses inherent risks. By over-minimizing product inventory, a company runs the risk of not having sufficient product inventory ready to ship to a customer if circumstances change. Insufficient product inventory can lead to lost sales, costs of expediting such as extra setup and transportation, and costs of interrupted production. These costs can decrease or eliminate gains in profit achieved by maintaining minimal product inventory.

Recent economic and political changes along with new security rules and procedures have slowed down the transportation system. Thus, a business that depends on receiving product inventory a short time after ordering it may not receive an order in time for sale to a customer. Also, increased threats could cause companies to locate more of their operations away from targeted areas and to decentralize some activities as well as use sources of supply that are closer to where they are needed. While any permanent change can be accounted for to a large degree within a product inventory minimization system, increased uncertainty makes product inventory shortfall a very real possibility with significant potential costs. It is thus desired to have an SCM optimization method that does not rely on minimizing product inventory.

Also, optimizing for product inventory overlooks important profit-maximizing business functions. Because product inventory minimization acts on only a portion of the supply chain, such optimization systems do not directly maximize cash on hand. Cash is essential for the survival and growth of any business. Regardless of how quickly products are turned around, unless these products are paid for, businesses—particularly small and midsize businesses—can quickly run out of cash. Without sufficient cash, businesses cannot pay their bills. Simply generating revenue—even vast quantities of it—does not guarantee profitability. Nor does rapid growth in sales. Unless a business has sufficient cash coming in to cover its expenses and fuel growth, it may well fail.

As the supply of cash in a business decreases, the cost of obtaining cash increases based on the laws of supply and demand, as well as the fact that cash-poor companies are a greater credit risk and are thus charged higher borrowing interest rates. For small companies with little or no market capitalization, even a few months of waiting for payments on accounts receivable can send the business into bankruptcy. Even if enough cash is collected in time to pay accounts payable, if the bills are paid late, interest charges increase as well as the costs associated with lowered credit. The fact that product inventory is minimized does nothing to change this situation. If a business cannot pay its bills on time, any profits achieved on paper derived from maintaining minimal product inventory will not necessarily offset the increased costs associated with a lack of cash.

In addition, without sufficient cash, businesses cannot adequately pursue corporate initiatives such as investment, acquisitions, equipment, marketing, and research and development. One of the most inexpensive ways to raise capital is to use a company's own money as leverage and generate internal capital. This is especially important for small businesses that often have trouble obtaining outside financing. Marketing is required to increase sales, and marketing requires cash. Cash is also needed to cover costs of modernizing or expanding the business. Also, maximizing cash allows businesses to finance assets in the least expensive way. With more cash on hand, loans and lines of credit can be paid down. In addition, with added cash, other less expensive means from the right side of the balance sheet, such as accounts payable, may be used to finance assets. Thus, while minimizing product inventory can lead to short term increases in profits, such minimization cannot necessarily sustain business profitability and growth success in the long run as maximization of cash can. Therefore, it is desired to have an optimization method that maximizes cash.

Finally, current product inventory optimization systems do not provide an Internet-based interface by which a customer can adjust and maintain constraints via inputting into the system and receiving output from the system. As discussed previously, for a product inventory optimization system to work, computer programming specialists are required to design, implement, alter, and maintain the system. The customer is involved in every step of the optimization process under current methods. This requires significant investment of time as well as human and financial resources such that small and midsize businesses are precluded from fully utilizing optimization technology. In addition, it moves the focus of the business from the business' area of expertise, presumably an area in which the business has a competitive advantage, to optimization technology, an area in which the business has no competitive advantage. This results in inefficient allocation of business resources.

A method providing an Internet-based interface by which a customer can adjust and maintain constraints via inputting into the system and receiving output from the system is desired because it saves the customer time, as well as financial and human resources, thus allowing small and midsize businesses to utilize optimization technology. This savings in time is particularly important for businesses to quickly evaluate business opportunities and their impact in order to take advantage of such opportunities as they arise. For example, if a supplier offers a discount on a product, the business needs to be able to quickly determine whether it should purchase at the sale price and how many units should be purchased. Because such opportunities are often available for only a short time, the optimization method must be capable of updating changes in data quickly. In this example, the price of the product on sale must be changed and the optimization process run to determine recommended purchases.

As noted, current optimization methods require either the in-house IT department or the outsourcing company to make the changes manually. An Internet-based interface would allow changes to be greatly automated. Such an interface would also add to the benefits of the method of optimization described previously, in which the customer can issue change requests, by allowing these change requests to be issued via the Internet. This would allow the customer to issue change requests from anyplace with an Internet connection. Not only would such an interface allow expedited inputting of information into the system and outputting to the customer, but it would allow all of the computational technology to be invisible to the customer so that all the customer is responsible for is uploading financial data and retrieving reports.

It is therefore desired to have an optimization method which does not require data manipulation by the customer while allowing the flexibility of being updated for business environment changes quickly, at low cost, and with few customer resources. In addition, it is desired to have an SCM optimization method that does not rely on minimizing product inventory. It is also desired to have an optimization method that maximizes cash, taking into account all levels of operational efficiency and profitability without the limitations of product inventory minimization. Finally, it is desired to have an SCM optimization method providing an Internet-based interface by which a customer can adjust and maintain constraints via inputting into the system and receiving output from the system.

### SUMMARY OF THE INVENTION

The present invention relates to a method and system for maximizing cash inventory. The method and system consist of obtaining financial data, organizing and preparing the financial data for submission to an optimization engine, processing the financial data using the optimization engine whereby cash inventory is maximized, and producing a solution for purchasing and distributing product inventory. In a process that is completely invisible to the customer, the customer's financial data is transferred to a vendor, the data is prepared for processing by an optimization engine, the data is optimized using the engine, and resulting recommendations are sent to the customer.

The financial data may be obtained via several formats, including file transfer protocol, Internet-based dashboard interface, floppy disk, removable storage media, hard copy, simple mail transfer protocol, and hypertext transfer protocol. The solution is presented via several reports, including a purchase recommendation report, a cash optimization report, and an inventory level report. The solution may be provided via several formats, including file transfer protocol, an Internet-based dashboard interface, a hard copy, files on a floppy disk, files on removable storage media, simple mail transfer protocol, and hypertext transfer protocol.

In the preferred embodiment of the invention, the customer can request and receive reports, submit change requests, and enter financial data via an Internet-based dashboard interface. The method and system allow the customer to input financial data into a computer and receive resulting reports from the same computer without having to do any data manipulation, programming, or calculations. The customer's responsibility is simply to input data and receive back reports. Thus, by simply entering its financial data into a web-based user interface, a customer can receive product inventory purchase recommendations that will maximize the customer's cash inventory.

The present invention is preferred over existing inventory optimization methods because current methods do not allow a customer to finance assets in the least expensive way. Existing methods focus on minimizing inventory, which does not yield as profitable results as does maximizing cash. The present method and system is also advantageous over existing processes because it provides a prepackaged optimization solution wherein a graphical user interface is provided between the optimization engine and the customer. Current methods of product inventory optimization place responsibility for design, implementation, and maintenance of the optimization interface upon the customer. The present invention requires no data manipulation by the customer and includes the flexibility to be updated for business environment changes quickly, at low cost, and with the use of few customer resources. By allowing the customer to input data and receive optimized results without the necessity of creating and maintaining an optimization interface, the current method and system saves the customer time as well as human and financial resources. Because of this savings, small and midsize businesses are able to make use of optimization technology.

In addition, the optimization interface in the present method and system allows for quick and easy analysis of changes in variables and constraints. If the value of a variable changes or business conditions force changes in constraints, the customer can submit a change request with the updated information and the optimization process will be rerun automatically. Existing methods require the customer to wait until either its in-house IT department or third party IT provider implement the required changes. Thus, the present method saves the customer time and minimizes the possibility of errors due to vendor familiarity with the optimization interface.

Finally, the present invention is preferred over existing processes because of the use of the Internet-based dashboard interface. A customer can enter financial data into a web-based graphical user interface and receive optimized results via the same interface. Not only does this simplify the task for the customer, saving time, but the customer can also enter data and receive results from anyplace with an Internet connection. This mobility is advantageous because it provides the customer with flexibility as well as cost savings in maintaining a dedicated optimization system. Allowing a customer to maintain its focus on business issues rather than optimization technology, the present invention permits more efficient allocation of customer resources.

### BRIEF DESCRIPTION OF THE DRAWINGS

FIG. 1 is a block diagram showing selected components of a customer's computer system upon which the present invention can be practiced;

FIG. 2 is a block diagram showing selected components of a vendor's computer system upon which the present invention can be practiced;

FIG. 3 is a block diagram showing information flow between a vendor's computer system and a customer's computer system within an optimization system in accordance with the present invention;

FIG. 4 is a flowchart showing an overview of an optimization system in accordance with the present invention;

FIG. 5 is a flowchart showing steps practiced of an optimization system in accordance with the present invention;

FIG. 6 is a flowchart continued from FIG. 5 showing steps practiced of an optimization system in accordance with the present invention;

FIG. 7 is a block diagram illustrating the data structures stored in the memory of a vendor's computer used in the present invention;

FIG. 8 is a purchase recommendation report showing results of the present invention for a fictitious customer;

FIG. 9 is a cash optimization report showing results of the present invention for a fictitious customer;

FIG. 10 is an inventory level report showing results of the present invention for a fictitious customer;

FIG. 11a is a screen shot of an Internet-Based Dashboard Interface showing a comparison report screen for a fictitious customer in accordance with the present invention;

FIG. 11b is a screen shot of an Internet-Based Dashboard Interface showing a purchase recommendation screen for a fictitious customer in accordance with the present invention;

FIG. 11c is a screen shot of an Internet-Based Dashboard Interface showing a forecast override screen for a fictitious customer in accordance with the present invention; and,

FIG. 11d is a screen shot of an Internet-Based Dashboard Interface showing an income and expenditure screen for a fictitious customer in accordance with the present invention.

### DETAILED DESCRIPTION

The present invention relates to a method and system for maximizing cash inventory. More specifically, the invention relates to a method and system for obtaining customer financial data and producing purchase recommendations for the customer which maximize the customer's cash inventory over a customer-defined period, typically one year. The customer can also request reports, submit change requests, and receive cash optimization and inventory level reports. The method allows the customer to input financial data into a computer and receive resulting reports from the same computer without having to do any data manipulation, programming, or calculations. The customer's responsibility is simply to put data in and receive reports back. The customer can also input financial data and receive reports using an Internet-based dashboard interface, also referred to as a dashboard, which is essentially an enhanced webpage, making the process even more convenient for the customer. Thus, by simply entering its financial data into a web-based user interface, a customer can receive product inventory purchase recommendations that will maximize the customer's cash inventory. Cash inventory is also referred to simply as cash.

In the present process the customer's financial data is transferred to a vendor, the data is prepared for processing by an optimization engine, the data is optimized using the engine, and resulting recommendations are sent to the customer. The transfer of data is invisible to the customer. The tasks of processing the data and transferring it to the optimization engine, as well as transferring the optimized data from the optimization engine and preparing it for transfer to the customer, are accomplished by an optimization interface. The optimization interface consists of four parts: an Internet-based dashboard, a pre-optimization preparation, a script (pre-engine and post-engine), and a model.

Thus, the five parts of the optimization method are the dashboard, the pre-optimization preparation, the script, the model, and the optimization engine, the first four form the optimization interface. The optimization interface is the point of interaction between the optimization engine—which contains the optimization algorithms, is not particular to any customer or field, and can be obtained from many alternative sources—and the customer. The optimization interface assembles and inputs data into the optimization engine so that the optimization engine can accept customer data, solve for the objective function, and generate a relevant report instructing a customer what actions to take so that the objective function is achieved. This interface feeds the data to be optimized into the optimization engine, retrieves the results, and allows the customer to change constraints or variable values and/or restart the optimization engine.

The dashboard is the customer interface through which the customer can send its financial data to the vendor, request and receive reports, and issue change requests. The pre-optimization preparation transfers the data entered via the dashboard and saves it to the vendor's system in a standardized form so that the optimization engine can read and process the data. The script (pre-engine script) further organizes the data and sets up the required electronic connections between the data and the engine. The model delineates the problem by defining the equations to be solved by the engine. The engine solves the equations, maximizing cash. The script (post-engine script) then prepares the results for transfer to the dashboard for viewing by the customer. The part of the script that occurs before use of the optimization engine can be referred to as the pre-engine script. The portion of the script that occurs after use of the optimization engine is also referred to as the post-engine script.

An Internet-based dashboard interface, or more simply termed, a dashboard, is the customer interface through which the customer can send its financial data to the vendor, request and receive reports, and issue change requests. Generally, Internet dashboards provide a way to both view and transfer information over the Internet through a single graphical user interface. Using technologies such as Active Server Pages (ASP), Java, Extensible Markup Language (XML), and Open Database Connectivity (ODBC), any corporate data, be it mainframe, email, groupware, or Web-resident, can be accessed from anyplace with Internet access. The preferred embodiment of the dashboard makes structured data from customer databases viewable by the customer through a graphical user interface. The dashboard is written using ASP, Java, and XML. The dashboard calls a vendor web server where all security issues are resolved and the appropriate screens are delivered.

The dashboard provides both read and write access via push/pull technology into a variety of databases. Pull refers to requesting data from another program or computer. The opposite of pull is push, where data is sent without a request being made. The terms push and pull are used frequently to describe data sent over the Internet.

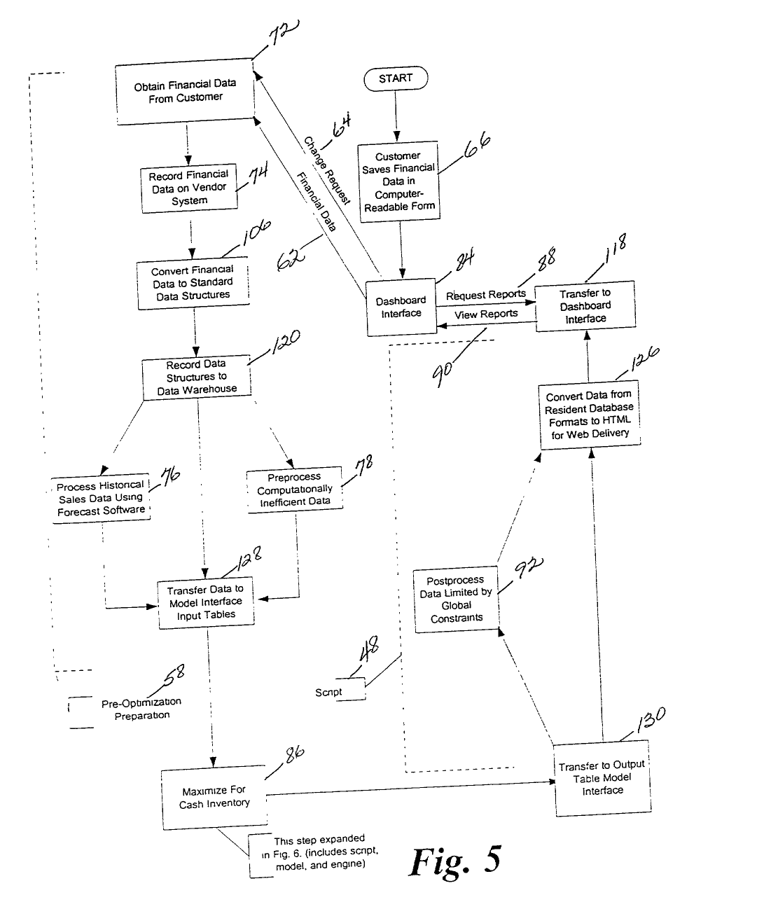

As shown in FIG. 5, the dashboard 84 is an online administration tool that allows a user to submit the financial data 62 and requests for results 88 of the optimization process, view results of the optimization process 90, and issue changes to data 64 from anywhere with an Internet connection. Such changes to data or change requests 64, may consist of changing variables and constraints. Examples of change requests include adding products, changing lead time, and instructing that a product can only be purchased in certain lots. Many other examples are possible. Other functions of the dashboard include viewing, sorting, and comparing financial data. The graphical user interface of the dashboard 84 allows the customer to make these inputs and receive output quickly and easily.

In particular, the dashboard provides various screens on which required information to be utilized by the optimization engine is provided. After the data is analyzed, answers are provided to the customer via the dashboard on what how much product inventory to purchase and when to purchase it. Additional recommendation may be included. The data required for entry into the dashboard will be discussed later. Results are provided in the form of reports as defined and discussed later in the description.

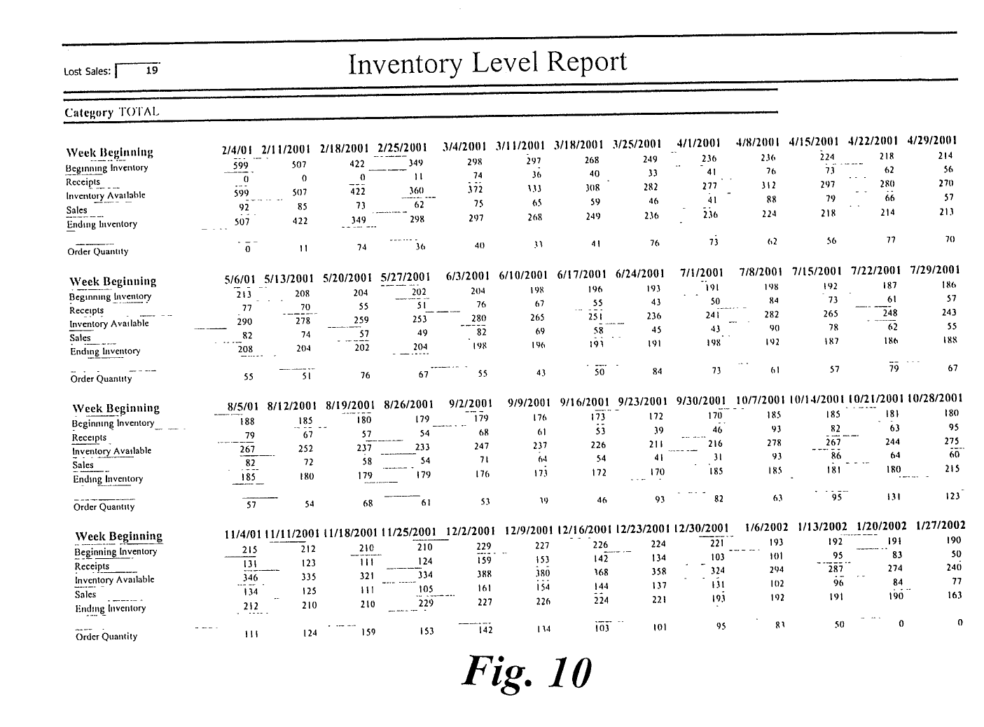

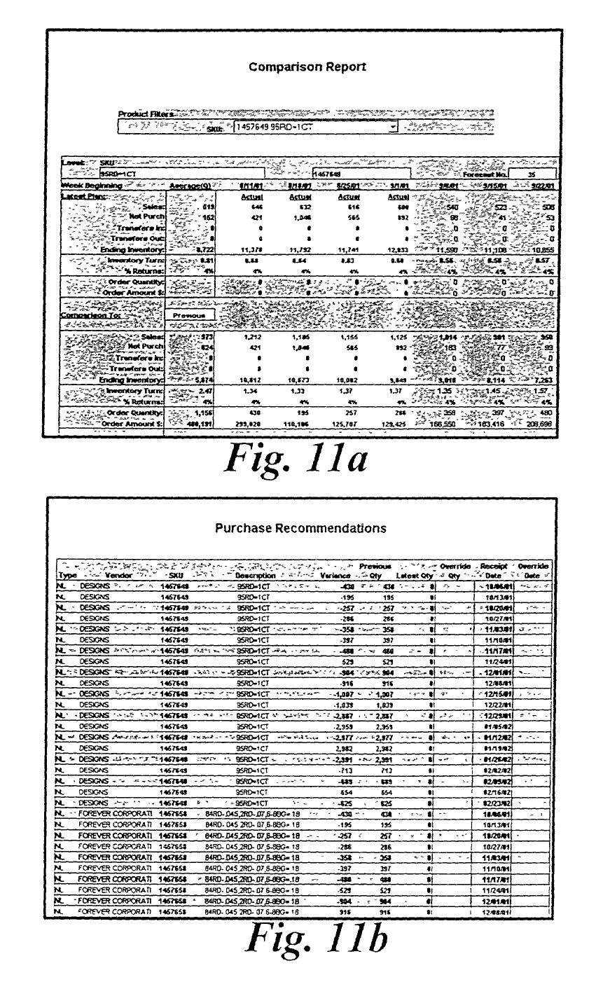

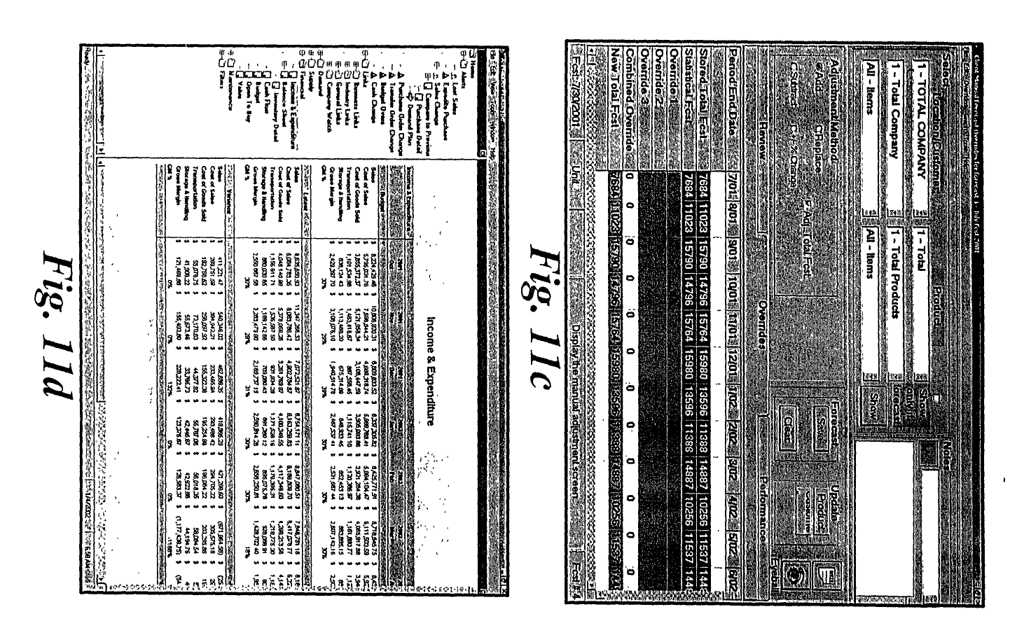

Screen shots of a dashboard representative of the preferred embodiment of the present method are shown in FIGS. 11a-d. A comparison report screen shown in FIG. 11a details a comparison of two products for a fictitious customer. Comparisons can be made of the data based on many parameters. FIG. 11b indicates a purchase recommendation screen showing two products for a fictitious customer. A forecast override screen shown in FIG. 11c shows a dashboard screen of a forecast override for a fictitious customer. A forecast override is used when forecasted data differs from actual data by more than an accepted variance level. FIG. 11d illustrates an income and expenditure dashboard screen for a fictitious customer. Such screens allow data to be viewed in tabular form.

Although in the preferred embodiment, the method uses the dashboard for customer inputting of data and transfer of the data to the vendor, other modes of obtaining and transferring the data are compatible with the present method including File Transfer Protocol (FTP) and electronic mail (email) using simple mail transfer protocol (SMTP).

Once the data is entered, as shown in FIG. 5, the pre-optimization preparation 58 transfers the data entered via the dashboard and saves it to the vendor's system in a standardized form so that the optimization engine can read and process the data. During the pre-optimization preparation, the customer's financial data is recorded on the vendor's system, converted into a standard form, and transferred to a data warehouse. The data is then either processed using forecasting software, arithmetically pre-processed, or left unprocessed, depending on the attributes of the data. The data is then transferred to model interface input tables containing all data fields required by the optimization engine.

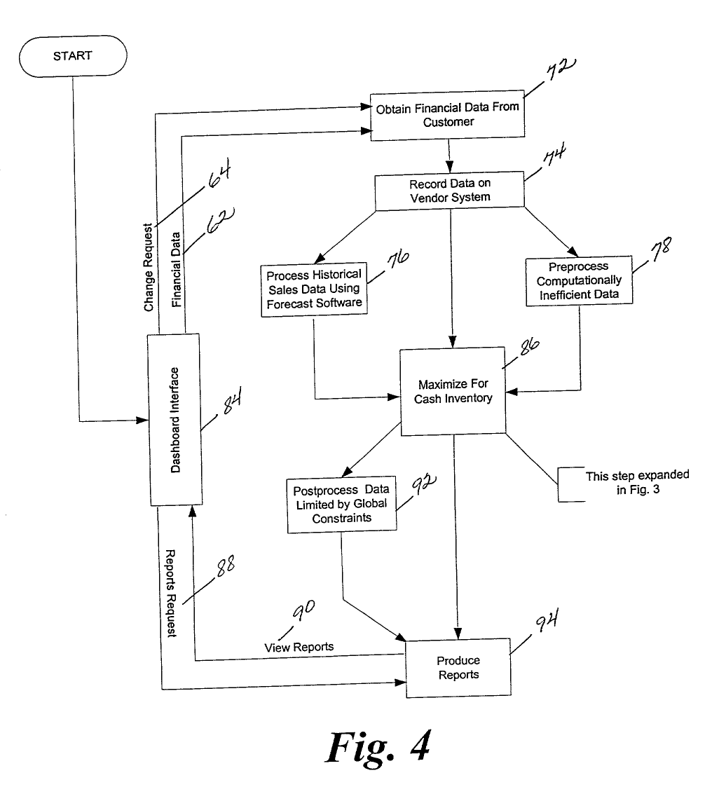

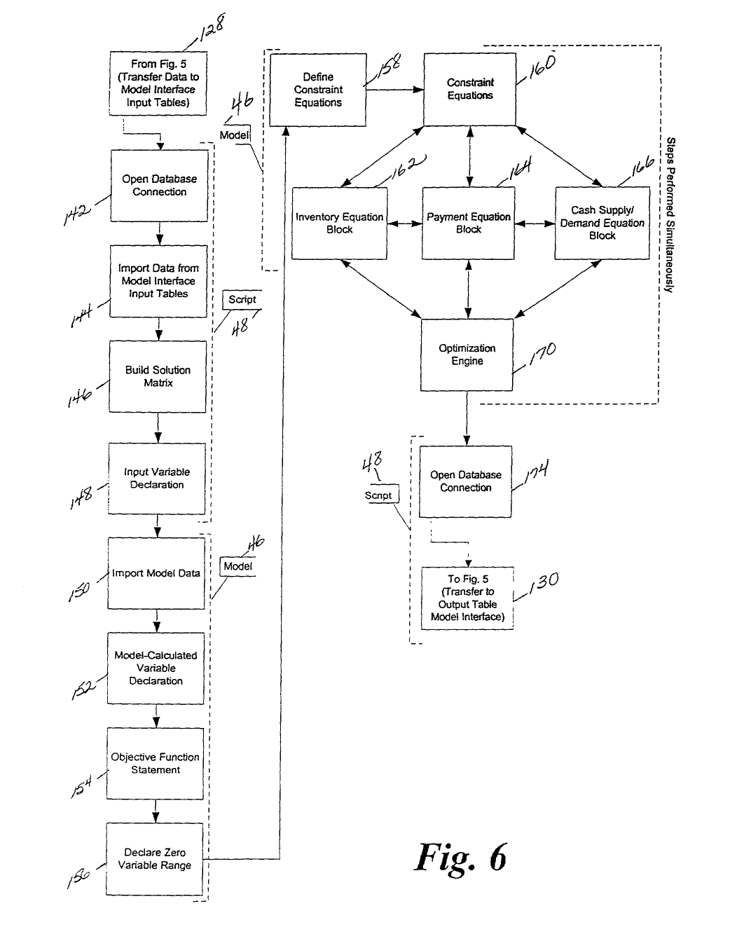

FIG. 4 provides an overview of the present method by illustrating the skeletal steps involved. A more detailed recitation of the process is shown in FIGS. 5 and 6. As can be seen in FIG. 5, the present method is initiated by the customer saving the financial data in computer-readable form 66. Although the vendor may obtain the data in other forms such as hard copy, this creates the need for the vendor to save the data in electronic form, and is not preferred because of the extra step required. Preferably, the data is saved in American Standard Code for Information Interchange (ASCII) text files (ASCII text files are referred to hereafter simply as text files) and then forwarded using the dashboard. Comma-delimited ASCII File (.cas files) or Comma Separated Values text file format (ASCII) (.csv files) are the preferred submission format for text files, but text files may also be submitted in other formats.

The financial data is then obtained from the customer 72. Preferably the financial data is obtained via the dashboard 62 as shown in FIGS. 4 and 5. Optionally, either a spreadsheet or text in an email using SMTP may be used to transfer the files depending on the size of the files. Alternatively, the files may be transferred by FTP or email attachments. The customer may optionally submit the financial data directly from its own database via FTP as well. The financial data may also be sent via other means such hypertext transfer protocol (HTTP), floppy disk, or removable storage media. HTTP is the underlying protocol used by the World Wide Web. HTTP defines how messages are formatted and transmitted, and what actions Web servers and browsers should take in response to various commands. In addition, the financial data may be transferred via hard copy, meaning that the copies exist physically on paper rather than electronically. Hard copy may be either written or printed.

The types of financial data submitted are varied because the data must be representative of the customer's business. Because businesses change over time, so can the types of data needed in order to accurately reflect the business. Regardless, the financial data can be categorized as general financial data, transactional data, and master data. General financial data refers to general information about the finances of the business typically listed in company financial reports, including company profit and loss accounts, balance sheet, and statements of cash flow. This is basic accounting data that conveys a customer's financial history and activities. Required general financial data includes data such as sales revenues, cost of goods sold, inventory, purchases (accounts payable), and receivables (accounts receivable).

Transactional data is data regarding actual business transactions such as purchases and sales. More specifically, transactional data is data related to a single business event such as a purchase requisition or a request for payment. Required transactional data includes data regarding sales history, supplier order receipt transactions, location transfer transactions, and product inventory on hand. Optionally, the transactional data may include data regarding supplier return transactions and other transactions. For the transactional data, required fields include product code, transaction date, location, and quantity.

Master data refers to constant information regarding specific products and particular locations. The difference between master data and transactional data is that master data is a record, or records, that remains unchanged in the system over an extended period of time whereas transactional data is the unique record, or records, the system creates as each transaction is completed. Required master data includes product information, location information, and product code linkages. Product code linkages are dependencies of one product code on another. Product information includes such data as product code, product description, product group, product group description, product retail price, product purchase cost, purchase lead time, vendor code, vendor description, vendor terms, vendor discounts, vendor minimum order information, minimum in-stock (cover) quantity, product introduction date, product transportation mode, and product discontinuation date. Location information includes such data as location code, location description, location lead time, and location opening date.

In addition to the financial data described, the present method optionally uses causal data to forecast future sales as described herein. Causal data refers to external factors that can affect sales but which the business has no control over.

As shown in FIGS. 4 and 5, the financial data obtained from the customer is recorded on the vendor computer system 74. This involves saving the transferred data to the vendor computer system memory and storing the data in the form in which it is transferred. The financial data is then converted into data structures 106. A data structure refers to a scheme for organizing related pieces of information and defines the way in which data are organized. A data structure is a logical organization of information to preserve its integrity and facilitate its use. More complex problems require more complex organizations of data that allow manipulation of sets of data. Full data base linkage, multiple layers and structures, and complex attributes mean more sophisticated structures are necessary. Because optimization is such a complex process, the level of data organization required is high. The basic types of data structures include files, lists, arrays, records, trees, and tables. Each of these basic structures has many variations and allows different operations to be performed on the data. The preferred data structures in the present method are arrays because their multidimensional capacity allows for the high degrees of organization required by the optimization process.

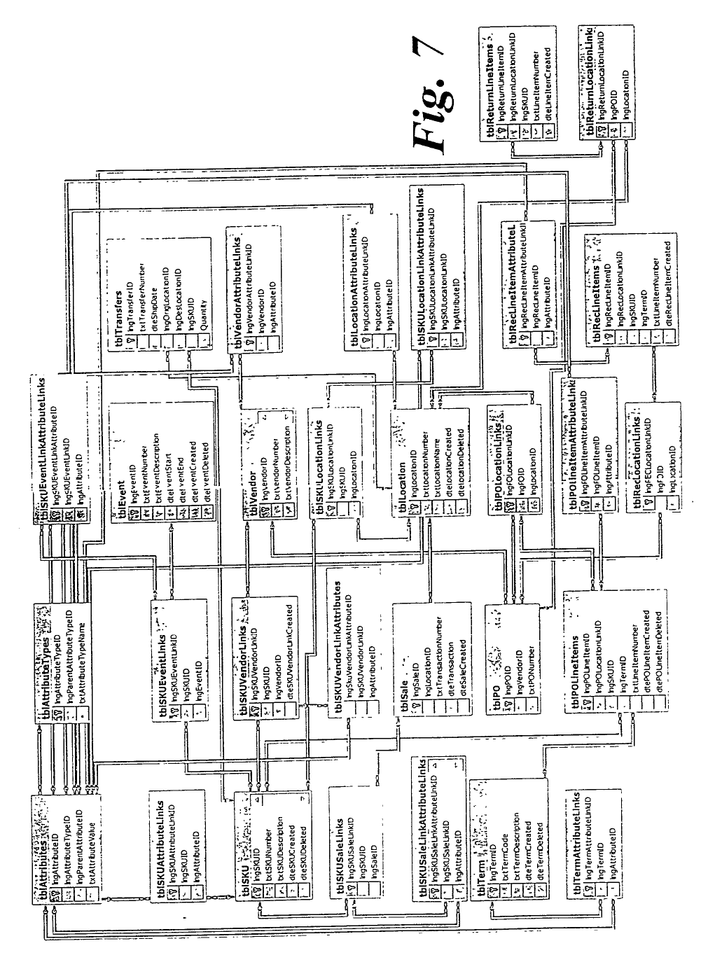

An array is a series of objects all of which are the same size and type. The entire array is stored contiguously in memory. Multidimensional arrays allow storage of multiple pieces of data about a product. A one-dimensional array is called a vector; a two-dimensional array is called a matrix. A three-dimensional array has height, width, and depth. While a two-dimensional array can be thought of as a table with rows and columns, a three-dimensional array can be imagined as a pile or deck of those tables. Each element is referenced by its layer, row, and column. There is no limit to the number of dimensions possible in an array, but it is difficult for people to visualize constructs with more than three dimensions as most real-world problems match logically with constructs of three or fewer dimensions. FIG. 7 shows one embodiment of the data structures compatible with the present method.

In the preferred embodiment, the data structures are based in structured query language (SQL). This enables several users on a local-area network (LAN) to access the same database simultaneously. Converting the financial data to data structures allows for uniform treatment of the financial data information regardless of a customer's legacy systems. It does not matter what format the customer's financial data is stored in when transferred from the customer's database. Thus, the data may be imported to the vendor system in Oracle®, dBase®, ASCII text, Microsoft® Access/SQL or other similar formats. The financial data is converted to data structures either manually or by data cleansing software. Data cleansing is the process of streamlining a database to remove duplicate records while standardizing the remaining data to an acceptable form. In the preferred embodiment, the data cleansing is performed by data cleansing software. Many commercial software packages are available for this purpose and are compatible with the present method.

The data structures containing the financial data are then recorded to a data warehouse 120. A data warehouse is essentially a collection of data designed for quick retrieval and decision making. It consists of data specifically structured for querying, analyzing, and reporting. Organizing the data in this manner minimizes processing resources.

Historical sales data, which is a subset of the transactional data, is abstracted from the transactional data and processed using forecasting software to statistically project future sales 76, typically for the following one-year period. The forecast is needed because future sales revenue is an important variable in the cash equation to be solved by the optimization engine. The forecast, which includes units to be sold, sales revenues anticipated, product, period, potential lost sales, and adjusted sales (unit sales minus potential lost sales), is then transferred to model interface input tables. The potential lost sales are only potential because such sales have not yet actually been lost. One of the goals achieved by the present methods is to minimize lost sales. This goal is met by allowing a customer to first view the potential lost sales, which are the number of sales that would be lost if no further corrective action in taken, and then make business decisions based upon a comparison of lost sales which would occur under several circumstances. Thus, because the number of lost sales may be diminished, these lost sales are referred to as potential lost sales. All forecasted data projections are archived to the data warehouse for later determination of forecast accuracy. This is done so as to have a baseline comparison with the reports. There are many forecasting software packages available which may be used to forecast future sales, though in the preferred embodiment, the forecasting software is Peer Planner® produced by Delphus, Inc.

In addition to sales history, causal data can optionally be inputted into the forecasting software, dependent upon a customer's particular business. This is done when forecasts are not accurate due to external factors unrelated to the customer's business. This ensures a better forecast because more factors that impact a business are considered. Causal data consists of external factors such as consumer confidence, housing starts, or interest rates which may affect forecast levels. Other causal data includes such factors and statistics as the consumer price index, producer price index, consumer credit, money supply, energy prices, rainfall, temperature, business inventories, unemployment figures, interest rates, air travel statistics, personal income, personal savings, commodity prices housing statistics, and real estate re-sales.

Computationally inefficient data from the financial data in the data warehouse is then pre-processed 78. This step minimizes system requirements such as processing time, memory, and processing power by quickly solving outside the optimization engine problems that cannot be efficiently solved using the engine. Certain mathematical operations and arithmetic are more efficiently dealt with outside the cash optimization engine. That is, there are fields required by the cash optimization engine which need to be combined or calculated before entering the engine. Most involve arithmetic operations that are dealt with inefficiently in the optimization engine itself. An example is returns to the manufacturer. If the return rate is 10%, it is much more efficient to pass the model a 90 unit actual receipt than to pass the model 100 units and force the arithmetic to be done, yielding 90 units actual, 10 returns, and 100 receipts.

There are two reasons why efficiency is maximized by this step, and why certain operations should be dealt with outside the optimization engine. First, for each variable processed by the optimization engine, a row in the matrix must be added. This adds considerably to the size of random access memory (RAM) required to solve the model, and adds to the solve time. Second, the optimization engine cannot allow “if” statements to be applied to variables to be solved in the engine. Therefore, if any data has conditional properties, the contingencies must be dealt with outside the optimization engine by pre-processing the data. There are many examples of operations which might require pre-processing in the preferred embodiment, including product returns, potential lost sales, and owned cash flow.

The data from the forecast software, pre-processed computationally inefficient data, and all other remaining data from the data warehouse are further organized by transferring the data to model interface input tables 128. This increases the efficiency of the optimization engine, minimizing required resources such as processing time, memory, and processing power by organizing all data in one place in a single format.

The model interface input tables are either a database or view into a data structure. The model interface input tables contain all data fields necessary for the optimization engine. Thus, rather than make multiple calls to outside data sources, the optimization engine will only need to make a single call from a homogeneous data structure. When the model optimization engine is run, all the data required to solve the equations must be available. The model interface input tables group the data together, even though the data comes from separate sources. Many database formats can be used. Certain database programs have space limitations, such as Microsoft® Access. In the preferred embodiment, the database is an SQL-based database because of ease of transferring data to and from the databases. Optionally, spreadsheets can be used in the model interface input tables, but are not preferred because they can strain the data structures.

Once the pre-optimization preparation is complete, as shown in FIG. 5 the script 48 further organizes the data and sets up the required electronic connections between the data and the engine. After the engine solves the equations, maximizing cash, the script prepares the results for transfer to the dashboard for viewing by the customer. Throughout the pre-engine part of the script, a database connection is opened, data is imported from the model interface input tables, a solution matrix is built, and variables are declared and typed. During the post-engine part of the script, a database connection is opened, the optimized results are transferred to an output table model interface, data that is limited by global constraints is post-processed, and the post-processed data as well as all other data from the output table model interface is converted to HTML for delivery via the dashboard.

As shown in FIG. 6, which shows an expanded view of the step to maximize for cash inventory 86 shown in FIGS. 4 and 5, after the data is transferred to the model interface input tables 128, a database connection is opened 142 using Open Database Connectivity (ODBC), a standard database access method developed by Microsoft® Corporation. This step allows the optimization engine to communicate with the data it requires. While optionally other data access methods may be used, ODBC is preferred because ODBC makes it possible to access any data from any application regardless of which database management system (DBMS) is handling the data. In the preferred embodiment, the DBMS used should be either Microsoft® Access or any SQL DBMS. Specifically, SQL Server, Oracle®, Sybase®, or Informix® are the preferred DBMS format. While many standard database access methods may be used with the present invention, utilization of ODBC-compliant applications and DBMS are preferred.

After the data is imported from the model interface input tables 144 via ODBC, the solution matrix 146 is built. The matrix is a two-dimensional array of rows and columns. The cash optimization engine must have all required data placed into one solution matrix so that the engine can call the data easily and efficiently, minimizing system resources. The solution matrix is built one variable at a time. The data required to solve the equations must be pulled out of the incoming databases and placed into the matrix. This step defines the data set in which the optimal solution resides.

Input variables must then be declared and typed 148. Declaration and typing mean defining the name and data type of a variable. This step is needed because many programming languages require variables to be declared before using them, including the preferred embodiment which uses C++ as the programming language. Optionally, other programming languages can be used with the present invention. All variables to be inputted into the optimization engine must be declared and typed. All variables that are to be used in the solve must be declared. For example, int begInv (1 . . . product) defines an integer begInv which represents beginning inventory which sets in an array of one observation per product.

The model 46 identifies the problem by defining the equations to be solved by the optimization engine. Whereas the pre-optimization preparation transfers and standardizes the data, and the script organizes and prepares the data, the model expresses the business mathematically so that the optimization engine can solve the equations to maximize cash. Without a question, there can be no answer, so the model defines a question which is later answered by the engine. Specifically, during the model, model data is imported, model-calculated variables are declared, an objective function statement is created, zero variable range is declared, constraint equations are defined, including an inventory equation block, a payment equation block, and a cash supply/demand equation block, and an optimization engine is called.

As shown in FIG. 6, after the variables are declared and typed in the script 148, the model data is imported 150. Variables passed from the script must be solved in the order defined in the matrix. These variables must be imported to the separate model structure. The model solves product-by-product. The script sends all data attached to each product and the model as a separate entity. The script also imports the data coming from the matrix and built in the script. Once in the model, data can be used by the optimization engine.

After importing the model data, model-calculated variables must be declared 152. The model requires variables that are not input variables. These include either interim, transport, or solution variables which must be declared before populating in the equations. Input variables come from the tables called in the script. Interim variables are used to temporarily store values during the solve process. Solution variables are the answers to the solve.

The objective function statement is then defined 154. The objective function is the goal of the process: to maximize, and in this case, to maximize for cash. Without the objective function statement, the optimization engine would not know what to do. Specifically, this statement defines the instruction to either maximize or minimize a single variable over a specified range, generally time. In the preferred embodiment of the invention, the objective function is to maximize, although other embodiments may allow for different objective functions.

It is then required to declare zero variable range 156. Based on certain limitations or constraints of the business rules, certain variable values will be zero. This step pre-defines their values as zero to save time and processing resources in the optimization engine. A variable's value is defined as zero by stating the time frame that the variable cannot be solved for, and setting it to zero by equation.

At a given point in time, various aspects of the way a business operates constrains what can be done. For instance, if lead time is three weeks for a product, then purchases in weeks one and two necessarily must equal zero. These values are defined in this step. Another example of a constraint which creates zero-value variables includes, in addition to purchases inside lead-time, inventory availability inside handle time. Other examples of limitations and/or constraints creating zero variable values are possible.

Constraint equations must then be defined 158. In this step, customer business constraints are translated into mathematical equations. One example of a business constraint is that inventory must be greater than or equal to zero. Another example is that a product cannot leave one location and arrive at another location at the same time. Other constraints that are mathematically translated are possible. Examples of such constraints include lead-time, handle time, shipping throughput, and handling throughput.

In addition to the baseline constraint equations, which apply to all businesses universally, other constraint equations may optionally be applied. When a customer submits a change request, for example, that orders can only be purchased in lots of twelve, then constraint equations may be optionally generated based on the customer's requirements.

In FIG. 6, the constraint equations step 160 simply reflects that the constraint equations have been defined. The constraint equations are used to simultaneously solve the inventory equation block 162, the payment equation block 164, and the cash supplies/demand equation block 166, using the optimization engine 170. The inventory, payment, and cash equations must all be present to simultaneously solve for the objective function within the constraints using the optimization engine 170. The base inventory equation is as follows:

Inventory(period)=Inventory(period−1)−Sales(period)+Purchases(period).

Inventory is subject to business constraints such as being greater than or equal to zero and being greater than or equal to safety stock.

The base payment equation is as follows:

Payment(period)=Purchases(period−payment term period)*Discount Allowed(period−payment term period)*Quantity Per Term(period−payment term period)

This equation is summed over total quantity per item, and then summed over all periods to determine periods

Cash supply and demand equations 166 include payments from the Payment equation block 164. Through this step, an ending cash position is obtained. The base cash equation is as follows:

Cash(period)=Cash(period−1)−Payment(period)+Sales Revenue(period).

The inventory payment and cash equations are simultaneously solved with an objective function of maximizing cash.

The model concludes by calling the optimization engine 170. It should be noted that the constraint equations 160, inventory equation block 162, payment equation block 164, cash supplies/demand equation block 166, and the optimization engine 170 all operate at the same time to deliver an optimized solution. The optimization engine solves the equations from the model using complex algorithms to maximize the customer's cash inventory, or more simply, cash.

The optimization engine utilizes an external firm's optimization algorithms to solve the equations for the stated objective function and produce an optimal solution. Here, the equations are solved within the stated constraints to maximize cash. The engine solves for each defined factor such as product and location.

The optimal solution is simply the best solution to the equations so that cash is maximized, while fulfilling all limitations and constraints. All time intervals defined in the data are provided for in the optimal solution. This is done step-by-step, product-by-product, and location-by-location. Thus, when product 1 is done, if there is a product 2, it is sent to the model until all products are solved for. When each product is solved, the process returns to the script to get the next product, and also to write the solution of the first product to the database. The model is called in the script, and the relevant data is passed. In the preferred embodiment, the optimization algorithm software is ILOG® CPLEX® optimization software, although optionally other optimization software can be used.

After the optimization engine determines the optimal solution, the script 48 then prepares the results for transfer to the dashboard for viewing by the customer. During the post-engine part of the script, a database connection is opened, the optimized results are transferred to an output table model interface, data limited by global constraints is post-processed, and the post-processed data along with all other data from the output table model interface is converted to HTML for delivery via the dashboard.

The optimization engine 170 returns an optimal solution. After the optimal solution is returned, a database connection is opened 174. The database connection is required to be opened so that after the model passes the solution to the script, the database is called to post the solution. Although other database access methods are possible, the preferred database access method is ODBC.

As seen in FIGS. 5 and 6, the next step is to transfer the data to the output table model interface 130 so as to organize the data in one place so that it may be quickly post-processed 92, converted to HTML 126, and transferred to the customer via the dashboard 118.

In transferring the data to the output table model interface 130, the optimized solution is posted to tables for reporting, reference, and archival. This step consists of a simple write to a database for reporting and archiving purposes. The tables consist of a database which is a collection of tables, queries, and forms. Any database form is acceptable, but in the preferred embodiment, the database format is either Microsoft® Access or SQL, depending on size. Optionally, a spreadsheet can be used, but this is not preferred.

Any data limited by global constraints is then post-processed 92. This step is optionally taken when business rules force constraints which are non-linear or sub-optimal. Much like the pre-processing step 78 from the pre-optimization, post-processing data limited by global constraints 92 minimizes processing requirements such as processing time, memory, and processing power by quickly solving outside the optimization engine problems that cannot efficiently be solved using the engine. Data limited by global constraints means data involving non-linear relationships and sub-optimal solutions.

Non-linear relationships take a substantial amount of time to solve using the cash optimization engine, and are thus better dealt with outside the engine. A non-linear relationship is a relationship that varies across one axis. Thus, if x=y for x being 1 to 10, and x=2(y) for x being 11 to 99, this defines a non-linear relationship. Unless the model is broken into two pieces, this problem cannot be solved. Non-linear constraints are essentially quadratic equations. The problem with quadratic relationships is that a given point on the y axis will have two solutions, whereas optimization requires one solution. For example, for a certain product, there may be a constraint on the total number of products that can go through a warehouse. Post-processing is used in this instance to determine that the preliminary optimal solution is still feasible within the larger constraint. This is similar to pre-processing the computationally inefficient data 124.

Sub-optimal solutions are solutions that the model cannot effectively deal with. For instance, the model may suggest that a customer purchase five units of product per week, but the manufacturer may only ship in the final week of the month. The optimal solution must be altered, or post-processed, to fit a real world situation. Thus, certain business rules insisted upon by a customer compel modification of the solution outside of the optimization engine. Most of these involve having to use “if” statements against solve dependent variables. These cannot be solved by the optimization engine. Another example is a customer who needs 77 items of a product that can only be shipped in units of 100. The optimal solution is 77, but the optimal solution must be post-processed to fit what must be done in the real world. Examples of post-processing include node throughput in processing (how much can be inputted or outputted through any facility), minimum purchase (to check optimal purchases of a single product within a group purchased discount), and transport discount (when some manufacturers require a certain purchase level across all their products in order to give all their products transportation discount).

The post-processed data and any remaining data from the output table model interface are then converted from resident database formats to HTML 126. This conversion is required so that the dashboard can read the results and display them for viewing by the customer. Because the dashboard is web-based, and because HTML is the authoring language used to create documents on the World Wide Web, HTML is typically used as the conversion language, though other web-viewable languages are possible, especially as the Internet and web evolve. This step links the solution tables and performs various arithmetic functions on data to set final preparations for data to be delivered to the customer. This step also pulls data from the solution tables and places the data in a pre-determined report format to be viewed over the Internet. The data is converted from its existing format to HTML for transfer to the customer via the Internet using the dashboard.

The next step is to transfer the data in HTML format via push/pull technology to the dashboard 118. The customer can use the dashboard interface 84 to request reports 88 and receive reports 90. The customer can also use the dashboard to issue a change request 64 or to initially send its financial data to the vendor.

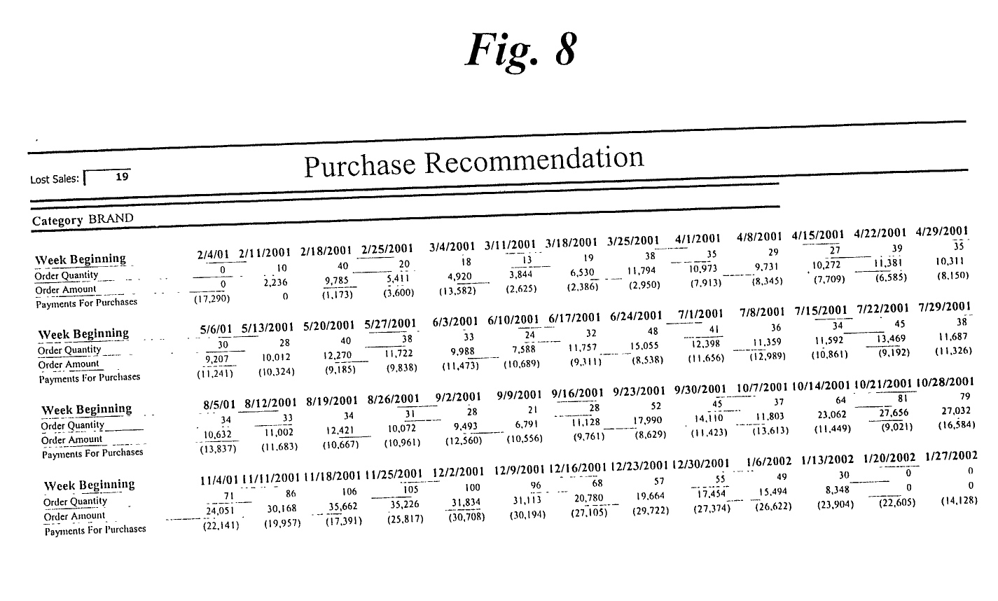

The method produces a solution for purchasing and distributing inventory in the form of produced reports 94. In the preferred embodiment of the method, three reports can be generated: purchase recommendations, cash optimization, and inventory level. As seen in FIG. 8, which shows a purchase recommendation report for a fictitious customer, in the preferred embodiment 20 of the method, the purchase recommendation report consists of recommendations for order quantity, order amount, and payments for purchases on a week-by-week basis starting at the present week for a user-specified number of weeks, typically a 52-week period. The coverage period of the report may be submitted via the dashboard interface. The number of potential lost sales (indicated simply as “lost sales”) are also indicated on the purchase recommendation report. Additional result parameters may optionally be shown based on the particular requirements of a customer.

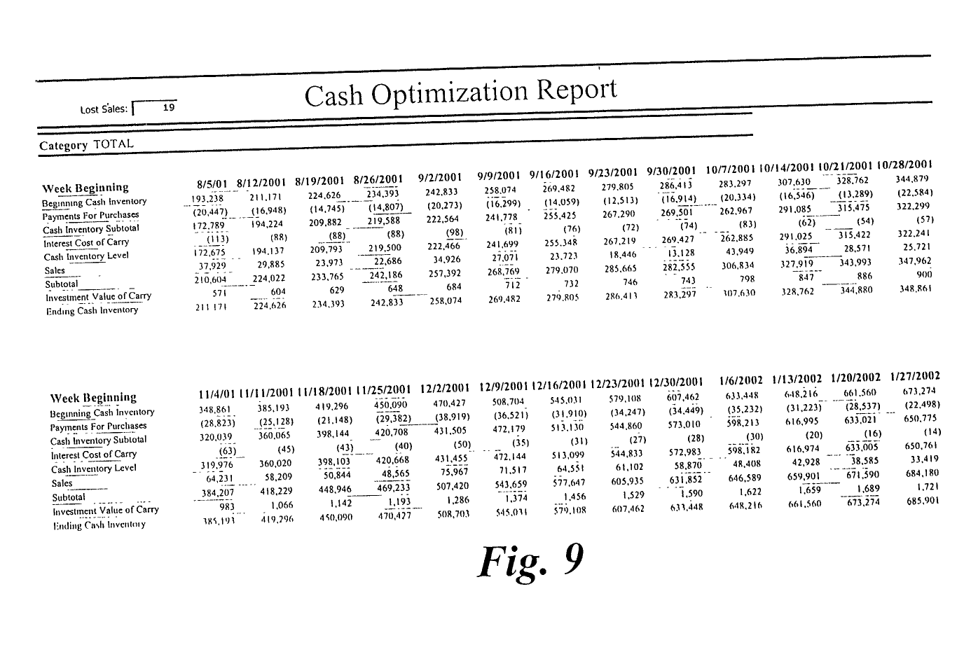

As seen in FIG. 9, which shows a cash optimization report for a fictitious customer, in the preferred embodiment of the method, the cash optimization report consists of results for beginning cash inventory, payments for purchases, cash inventory subtotal (consisting of the sum of beginning cash inventory and payments for purchases), interest cost of carry, cash inventory level, sales, subtotal (consisting of cash inventory level plus sales), investment value of carry, and ending cash inventory on a week-by-week basis starting at the present week for a user-specified number of weeks, typically a 26-week period. The number of potential lost sales (indicated simply as “lost sales”) are also indicated on the cash optimization report. Additional result parameters may optionally be shown based on the particular requirements of a customer.

As seen in FIG. 10, which shows an inventory level report for a fictitious customer, in the preferred embodiment of the method, the inventory level report consists of results for beginning (product) inventory, receipts, inventory available, sales, ending inventory, and order quantity on a week-by-week basis starting at the present week for a user-specified number of weeks, typically a 52-week period. Optionally, the customer can also receive reports 90 on the accuracy of the forecast sales generated by the forecast software 76. Because all forecast data is archived during the forecasting process, current figures of actual sales can be compared with the forecasted figures. The number of potential lost sales (indicated simply as “lost sales”) are also indicated on the inventory level report. Additional result parameters may optionally be shown based on the particular requirements of a customer.

If the customer wants a forecast accuracy report, the customer may either contact the vendor directly, or more preferably, issue a request for a forecast accuracy check through the dashboard 84. The customer inputs the date range, product, and location for which the forecast accuracy check is desired, as well as the corresponding actual sales figures. The request submitted via the dashboard is transferred electronically to the vendor computer via the Internet.

The archived forecast figures are then called and compared with the actual figures to determine whether the forecasted sales vary from the actual sales by an amount that the customer determines is acceptable. The default standard is +/− two standard deviations, but any standard can be used. The customer may optionally change this standard via the dashboard or by contacting the vendor. The customer may override the forecast to take into account subjective management opinions or additional information that is not reflected in the baseline forecast. A forecast override is used when forecasted data differs from actual data more than the accepted variance level. The customer may issue such an override via the dashboard. FIG. 11c shows a forecast override screen shot for a fictitious customer.

The results are then sent electronically to the customer, who is alerted via the dashboard that the report is available. The customer may either view the results on the computer display, 90 or print a report with the results. The customer can then make decisions based on the reports such as changing variables (for example, lowering price) or changing constraints (for instance, using a wholesaler who ships more frequently). These changes can then be fed back into the optimization process so that the effects can be seen in updated purchase recommendation, cash optimization, and inventory level reports.

Much like forecast accuracy checks, accuracy checks may be conducted for other parameters. These projection accuracy checks are comparisons of projected versus actual numbers using similar means as for the forecast accuracy check. Projection accuracy checks can be run for inventory, receipts, expedited receipts, as well as other parameters listed on the reports for purchase recommendations, cash optimization, and inventory level. In this case, the actual numbers are compared with the projected figures listed in these reports. Again, an acceptable variance level can be defined by the customer. A positive projection accuracy check is defined as one in which the actual and projected figures are not within the accepted variance level. A negative projection accuracy check is defined as one in which the actual and projected figures are within the accepted variance level. Based upon a projection accuracy check, the customer may override the projected figures in the reports using the dashboard via a projection override in much the same way as a forecast override. Both forecast overrides and projection overrides are considered change requests.

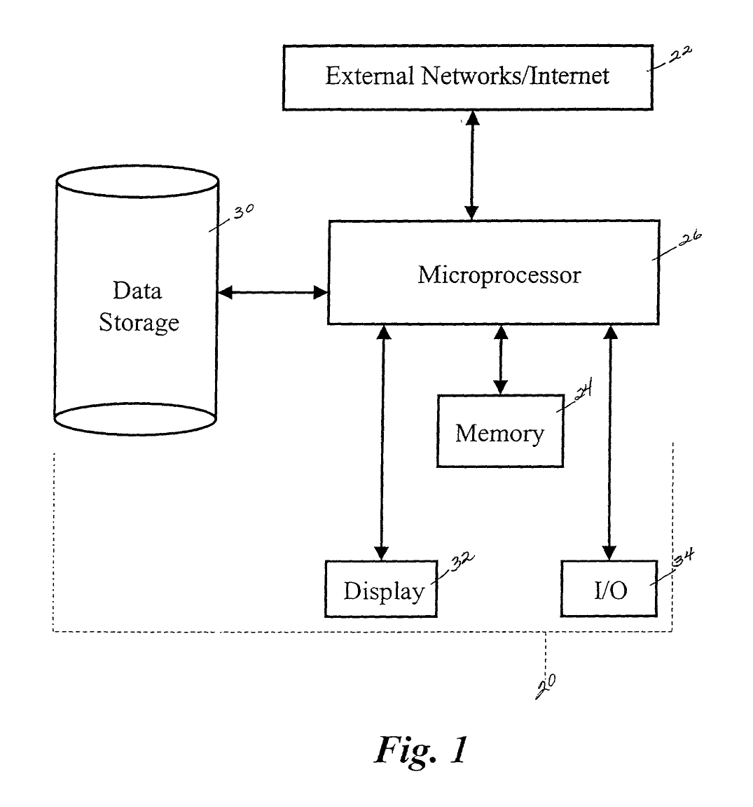

A computer is necessary to initiate the present method and is included as part of a system for maximizing cash according to the present invention. FIG. 1 is a block diagram of the preferred embodiment of a customer's system, indicated generally at 20, for maximizing return of cash inventory according to the present invention. The system 20 can be a personal computer, computer workstation, or other suitable computing device. As shown, the system 20 includes a microprocessor 26, memory 24, data storage 30, a display 32, I/O (input/output) 34, and external networks/Internet 22. Typical data storage 30 includes mass storage devices such as hard disks as well as removable media devices such as removable hard disks and CD-ROM. I/O 34 describes any operation, program, or device that transfers data to or from a computer. Typical I/O devices are printers, hard disks, keyboards, and mice. External networks/Internet 22 typically includes a connection to the Internet as well as internal and/or external network connections. The Internet connection can be of any type by which the system 20 can communicate with other computers on the Internet such as dial-up connections, direct connections, cable service connections, and digital subscriber lines. The network connections can include local-area networks (LANs), wide-area networks (WANs), campus-area networks (CANs), metropolitan-area networks (MANs), and home-area networks (HANs). The network connections may overlap with the Internet connections such that a network connection is used to access the Internet. System 20 could include other computer components as well.

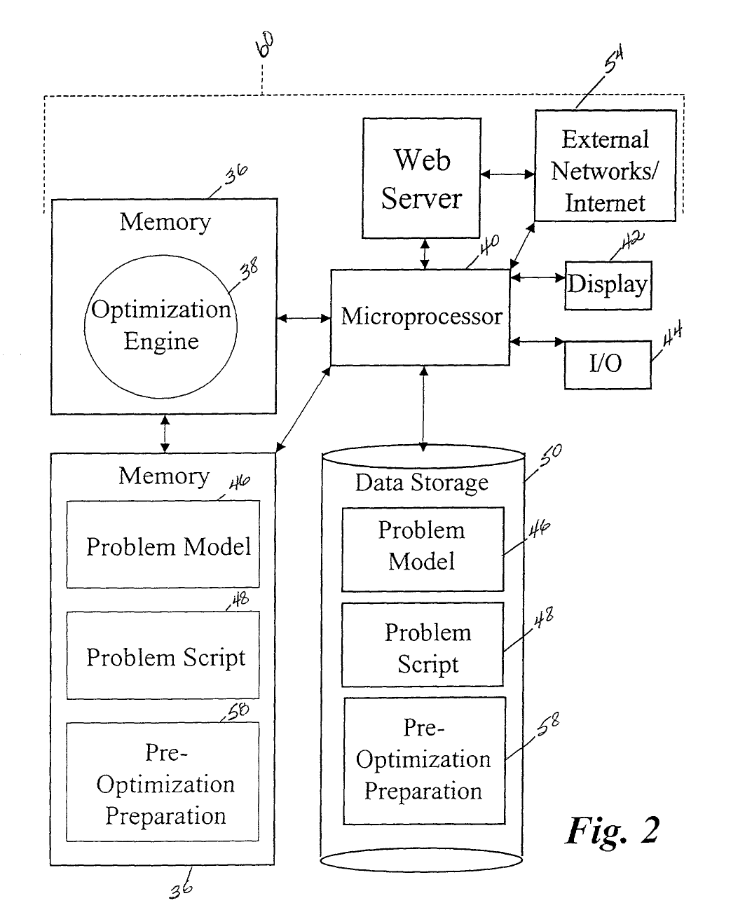

In the preferred embodiment, the microprocessor 26 is at least a single Intel® Pentium® processor running at a minimum of 500 MHz although the present invention can be used with other microprocessors as well. The microprocessor 26 need not be as fast as microprocessor 40 in vendor's computer system 60 depicted in FIG. 2 because the customer computer system 20 does no calculation of the optimization process (including the optimization engine) but rather acts to receive input from the customer for transfer and calculation to vendor computer system 60 and receive output from vendor computer system 60. The microprocessor 26 is connected to the memory 24. The memory 24 is typically Dynamic Random Access Memory (DRAM) or Synchronous Dynamic Random Access Memory (SDRAM) configured in Single Inline Memory Modules (SIMM) and consists of a minimum of 64 megabytes (MB). The preferred embodiment of the present invention is implemented on the Microsoft® Windows® 2000 operating system upon which source code files are written specifically to execute in that environment. Other operating systems and source code combinations can be employed.

Obviously, a vendor will have a computer with which to perform calculations and process data. FIG. 2 is a block diagram of one embodiment of such a vendor system, indicated generally at 60, for maximizing return of cash inventory according to the present invention. The system 60 can be a personal computer, computer workstation, or other suitable computing device. As shown, system 60 includes a microprocessor 40, memory 36, data storage 50, a web server 56, a display 42, I/O 44, and external networks/Internet 54. Typical data storage 50 includes mass storage devices such as hard disks as well as removable media devices such as removable hard disks and CD-ROM. I/O 44 describes any operation, program, or device that transfers data to or from a computer. Typical I/O devices are printers, hard disks, keyboards, and mice. External networks/Internet 54 typically includes a connection to the Internet as well as internal and/or external network connections. The web server 56 is optionally directly connected to the microprocessor 40. The Internet connection can be of any type by which the system 60 can communicate with other computers on the Internet such as dial-up connections, direct connections, cable service connections, and digital subscriber lines. The network connections can include local-area networks (LANs), wide-area networks (WANs), campus-area networks (CANs), metropolitan-area networks (MANs), and home-area networks (HANs). The network connections may overlap with the Internet connections such that a network connection is used to access the Internet. The system 60 could include other computer components as well.

In the preferred embodiment, the microprocessor 40 consists of dual Intel® Pentium® processors, each running at a minimum of 500 MHz, although the present invention can be used with other microprocessors as well, including single, quadruple, and other multiples of processors. The microprocessor 40 is connected to the memory 36. Memory 36 is shown in two separate compartments to indicate that an optimization engine required for the present invention is part of the vendor computer system memory but is not proprietary to the inventory of the present invention. The memory 36 is continuous and not physically or structurally separated. The memory 36 is typically Dynamic Random Access Memory (DRAM) or Synchronous Dynamic Random Access Memory (SDRAM) configured in Single Inline Memory Modules (SIMM) and consists of a minimum of 512 megabytes (MB).

Data storage 50 stores data representing a model 46, a script 48, and a pre-optimization preparation 58 that define a system using constraints according to the present invention. An optimization engine 38 stored in memory 36 and executed by processor 40 directs system 60 to perform the optimization method of the present invention using model 46, script 48, and pre-optimization preparation 58. The model 46, script 48, and pre-optimization preparation 58 can be stored in memory 36 and used by optimization engine 38 rather than needing to access data storage 50. When an optimal result is identified by optimization engine 38, the result can be stored as data on data storage 50 as well as outputted to display 42, to I/O devices 44, or to external networks or Internet 54. The preferred embodiment of the present invention is implemented on the Microsoft® Windows® 2000 operating system upon which source code files are written specifically to execute in that environment. Other operating systems and source code combinations can be employed.

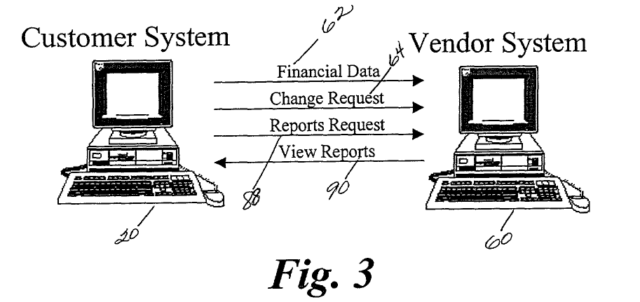

FIG. 3 is a block diagram showing information flow between a vendor's computer 60 and a customer's computer 20 within an optimization system in accordance with the present invention. As indicated in FIG. 3, customer system 20 inputs include financial data 62, change request 64, and reports request 88. Vendor system 60 inputs include reports 90 based on customer inputs financial data 62, change request 64, and reports request 88.

Thus, there has been shown and described a method and system for maximizing return of cash inventory which fulfills all the objects and advantages sought therefore. It is apparent to those skilled in the art, however, that many changes, variations, modifications, and other uses and applications for the method and system of maximizing cash inventory are possible, and also such changes, variations, modifications, and other uses and applications which do not depart from the spirit and scope of the invention are deemed to be covered by the invention, which is limited only by the claims which follow.

What is claimed is:

1. A method for maximizing cash inventory wherein the method comprises:
(a) obtaining financial data;
(b) organizing and preparing the financial data for submission to an optimization engine;
(c) processing the financial data using the optimization engine whereby cash inventory is maximized; and,
(d) producing a solution for purchasing and distributing product inventory.

2. The method of claim 1, wherein the financial data is obtained via a format selected from the group consisting of file transfer protocol, Internet-based dashboard interface, floppy disk, removable storage media, hard copy, simple mail transfer protocol, hypertext transfer protocol, and combinations thereof.

3. The method of claim 1, wherein the financial data is obtained via an Internet-based dashboard interface.

4. The method of claim 1, wherein the financial data is obtained via file transfer protocol.

5. The method of claim 1, wherein the financial data comprises master data, transactional data, historical sales data, and combinations thereof.

6. The method of claim 1, wherein the solution is presented via a report selected from the group consisting of purchase recommendation report, cash optimization report, inventory level report, and combinations thereof.

7. The method of claim 1, comprising providing the solution via a format selected from the group consisting of file transfer protocol, Internet-based dashboard interface, hard copy, floppy disk, removable storage media, simple mail transfer protocol, hypertext transfer protocol, and combinations thereof.

8. The method of claim 1, comprising providing the solution via an Internet-based dashboard interface.

9. The method of claim 1, wherein step b of claim comprises using forecasting software to input historical sales data and generate sales forecasts.

10. The method of claim 1, wherein the customer can issue a projection override via an Internet-based dashboard interface.

11. The method of claim 1, comprising the step of alerting a customer of a positive projection accuracy check via an Internet-based dashboard interface.

12. The method of claim 1, wherein a customer can submit change requests via an Internet-based dashboard interface.

13. The method of claim 9, wherein the customer can issue a forecast override via an Internet-based dashboard.

14. The method of claim 9, comprising alerting the customer whether forecasted sales deviate from actual sales by an acceptable variance level.

15. The method of claim 14, wherein the acceptable variance level is selected by a customer.

16. The method of claim 14, wherein the acceptable variance level is selected using an Internet-based dashboard interface.

17. The method of claim 14, wherein the acceptable variance level is two standard deviations.

18. A method for maximizing cash inventory wherein the method comprises:
(a) obtaining financial data;
(b) converting the financial data to data structures;
(c) transferring the data structures into model interface input tables;
(d) processing the data from the model interface input tables using an optimization engine whereby future cash inventory is maximized, producing a set of optimized data;
(e) transferring the set of optimized data to an output table model interface;
(f) converting the output table model interface data from resident database formats to a format whereby the data is accessible by web browsers;
(g) transferring the data accessible by web browsers to an Internet-based dashboard interface; and,
(h) providing an optimal solution for purchasing and distributing inventory.

19. The method of claim 18, wherein a customer can issue a projection override via an Internet-based dashboard interface.

20. The method of claim 18, wherein a customer can submit change requests via an Internet-based dashboard interface.

21. The method of claim 18, comprising providing the solution via a format selected from the group consisting of file transfer protocol, hard copy, Internet-based dashboard interface, floppy disk, removable storage media, simple mail transfer protocol, hypertext transfer protocol, and combinations thereof.

22. The method of claim 18, wherein the solution for purchasing and distributing inventory is presented via a report selected from the group consisting of purchase recommendation report, cash optimization report, inventory level report, and combinations thereof.

23. The method of claim 18, comprising providing the solution via an Internet-based dashboard interface.

24. The method of claim 18, wherein the financial data is obtained via a format selected from the group consisting of file transfer protocol, Internet-based dashboard interface, floppy disk, hard copy, removable storage media, simple mail transfer protocol, hypertext transfer protocol, and combinations thereof.

25. The method of claim 18, wherein the financial data is obtained via an Internet-based dashboard interface.

26. The method of claim 18, wherein the financial data is obtained via file transfer protocol.

27. The method of claim 18, comprising repeating steps (a) to (h) each time a change request is received from a customer.

28. The method of claim 18, comprising pre-processing computationally inefficient data from the data structures.

29. The method of claim 18, comprising post-processing the optimized data limited by global constraints.

30. The method of claim 18, wherein the format whereby the data is accessible by web browsers is selected from the group consisting of hypertext markup language, extensible hypertext markup language, extensible markup language, standard generalized markup language, extensible stylesheet language, cascading style sheets, and combinations thereof.

31. The method of claim 18, comprising the step of alerting a customer of a positive projection accuracy check via an Internet-based dashboard interface.

32. The method of claim 18, wherein the financial data is selected from the group consisting of master data, transactional data, historical sales data, and combinations thereof.

33. The method of claim 27, wherein the change request is received through an Internet-based dashboard interface.

34. The method of claim 28, wherein the computationally inefficient data is selected from the group consisting of product returns, potential lost sales, owned cash flow, and combinations thereof.

35. The method of claim 29, wherein the optimized data limited by global constraints are selected from the group consisting of node throughput and processing, minimum purchases, transport discounts, and combinations thereof.

36. The method of claim 32, comprising processing the historical sales data using forecasting software to forecast future sales.

37. The method of claim 36, wherein the customer can issue a forecast override via an Internet-based dashboard.

38. The method of claim 36, comprising the step of alerting a customer when forecasted sales deviate from actual sales by an acceptable variance level.

39. The method of claim 38, wherein the alert to the customer is accomplished via an Internet-based dashboard interface.

40. The method of claim 38, wherein the acceptable variance level is selected by a customer.

41. The method of claim 38, wherein the acceptable variance level is selected using an Internet-based dashboard interface.

42. The method of claim 38, wherein the acceptable variance level is two standard deviations.

43. A method for maximizing cash inventory wherein the method comprises:
(a) obtaining financial data;
(b) transferring and saving the financial data to a vendor's system in a standardized form;
(c) organizing the financial data in a data warehouse;
(d) defining equations to be solved by an optimization engine;
(e) defining an objective function for the optimization engine to accomplish;
(f) solving the equations for the objective function using the optimization engine; and,
(g) producing reports indicating when and how much product inventory to purchase.

44. The method of claim 43, wherein the financial data is obtained via an Internet-based user interface.

45. The method of claim 43, wherein the financial data is obtained via file transfer protocol.

46. The method of claim 43, wherein the equations to be solved by the optimization engine are selected from the group consisting of constraint equations, a base payment equation, base inventory equation, and base cash equation.

47. The method of claim 43, wherein change requests are made via an Internet-based user interface.

48. The method of claim 43, wherein the objective function is to maximize.

49. The method of claim 43, wherein the objective function is to maximize for cash.

50. The method of claim 43, wherein the reports are transferred via the Internet for display using an Internet-based dashboard interface.

51. A computer-implemented method for utilizing an optimization engine to maximize cash inventory wherein the method comprises:
(a) inputting financial data of a customer into computer-readable form on a customer's computer system;
(b) transferring the financial data electronically from the customer's computer system to a vendor's computer system;
(c) processing the financial data using an optimization engine to obtain results that maximize cash inventory without action by the customer; and,
(d) transferring purchase recommendations which maximize cash inventory based on the results electronically from the vendor's computer system to the customer's computer system.

52. A computer-implemented method for utilizing an optimization engine to maximize cash inventory wherein the method comprises:
(a) utilizing an optimization interface to save a customer's financial data to a vendor's system in a standardized form, organize the data, and define equations to be solved by an optimization engine so the customer can input financial data and receive back reports which maximize cash inventory whereby the customer does not manipulate data, program data, or perform calculations on the data; and,
(b) solving the equations from the optimization interface subject to user-defined constraints using an optimization engine.

53. A computer-based system for utilizing an optimization engine to maximize cash inventory comprising:
(a) an optimization interface consisting of an Internet-based dashboard interface, a script, a model, and a pre-optimization interface, whereby the optimization interface saves a customer's financial data to a vendor's system in a standardized form, organizes the data, and defines equations to be solved by an optimization engine so the customer can input financial data and receive back reports which maximize cash inventory whereby the customer does not manipulate data, program data, or perform calculations on the data; and,
(b) an optimization engine which solves the equations from the optimization interface subject to user-defined constraints.

54. A computer-based system for maximizing cash inventory wherein the system comprises:
(a) an Internet-based dashboard interface wherein financial data, change requests, and reports requests may be inputted and reports may be outputted;
(b) a pre-optimization preparation which transfers and saves the data inputted via the dashboard to a vendor's system in a standardized form such that an optimization engine can read and process the data;
(c) a pre-engine script which organizes the data and sets up the required electronic connections between the data and the optimization engine;
(d) a model which defines equations to be solved by the optimization engine; and,
(e) the optimization engine which solves the equations, maximizing cash.

55. The system of claim 54, wherein the financial data is obtained via a format selected from the group consisting of file transfer protocol, Internet-based dashboard interface, floppy disk, removable storage media, hard copy, simple mail transfer protocol, hypertext transfer protocol, and combinations thereof.

56. The system of claim 54, wherein the financial data is obtained via file transfer protocol.

57. The system of claim 54, wherein a customer can issue a projection override via the Internet-based dashboard interface.

58. The system of claim 54, wherein a customer is sent an alert via the Internet-based dashboard interface when a positive projection accuracy check is issued.

59. The system of claim 54, wherein a customer submits change requests via the Internet-based dashboard interface.

60. The system of claim 54, comprising using forecasting software to forecast future sales during the pre-optimization preparation.

61. The system of claim 60, comprising a customer issuing a forecast override via an Internet-based dashboard.

62. The system of claim 60, comprising issuing an alert to a customer when forecasted sales deviate from actual sales by an acceptable variance level.

63. The system of claim 62, wherein the acceptable variance level is selected by a customer.

64. The system of claim 62, wherein the acceptable variance level is selected using the Internet-based dashboard interface.

65. The system of claim 62, wherein the acceptable variance level is two standard deviations.
